(19) United States
(12) Patent Application Publication
(10) Pub. No.: US 2011/0151295 A1
(43) Pub. Date: Jun. 23, 2011

(54) Electrode assembly and secondary battery using the same

(76) Inventor: Kwang-Chun Kim, Suwon-si (KR)

(21) Appl. No.: 12/926,841

(22) Filed: Dec. 13, 2010

(30) Foreign Application Priority Data
Dec. 17, 2009 (KR) 10-2009-0126077

(51) Int. Cl. H01M 2/26; H01M 10/36; H01R 43/02

(52) U.S. Cl. 429/94; 429/211; 29/623.1; 29/877

(57) ABSTRACT

An electrode assembly includes a positive electrode plate including a positive electrode active material layer and positive electrode uncoated areas on a positive collector, a negative electrode plate including a negative electrode active material layer and negative electrode uncoated areas on a negative collector, the negative electrode active material layer having a negative electrode active material on the negative electrode collector, and the negative electrode uncoated areas having no negative electrode active material, a separator interposed between the positive electrode plate and the negative electrode plate, and a positive electrode tab set and a negative electrode tab set. The positive electrode tab set includes a plurality of positive electrode tabs being folded portions of the positive electrode uncoated areas and coupled to each other, and the negative electrode tab set includes a plurality of negative electrode tabs being folded portions of the negative uncoated areas and coupled to each other.

### BACKGROUND

1. Field

Embodiments relate to an electrode assembly, a secondary battery using the same, and a method of forming the electrode assembly. More particularly, embodiments relate to an electrode assembly capable of satisfying an operation characteristic of a large battery and a secondary battery using the same.

2. Description of the Related Art

In general, a secondary battery refers to a chargeable and dischargeable battery, unlike a non-chargeable primary battery, and is used for high-tech electronic apparatuses, e.g., a mobile telephone, a laptop computer, and a camcorder. For example, the secondary battery may include a lithium battery, a Ni—Cd battery, and a Ni—MH battery.

An operating voltage of the lithium ion secondary battery, i.e., about 3.7 V, is about three-times higher than the operating voltage of a Ni—Cd battery or a Ni—MH battery, and an energy density per unit weight of the lithium ion secondary battery is high. Therefore, use of the lithium ion secondary battery is rapidly increasing.

In a conventional lithium ion secondary battery, a lithium based oxide is used as a positive electrode active material and a carbon material is used as a negative electrode active material. The lithium ion secondary battery may be divided into a liquid electrolyte battery and a polymer electrolyte battery in accordance with the kind of electrolyte used. A battery that uses a liquid electrolyte is referred to as a lithium ion battery and a battery that uses a polymer electrolyte is referred to as a lithium polymer battery. In addition, the lithium ion secondary battery may be manufactured to have various shapes, e.g., a cylinder, a can, and a pouch.

For example, a can type lithium ion secondary battery may include a can, an electrode assembly in the can, and a cap assembly sealing the can. The can may be made of a, e.g., rectangular, metal material and may function as a terminal. In addition, the can may include an upper end opening so that the electrode assembly may be accommodated through the upper end opening.

The cap assembly may include a cap plate, an insulating plate, a terminal plate, and an electrode terminal. The cap assembly may be coupled to an additional insulating case and to the upper end opening of the can to seal up the can.

The electrode assembly may include a positive electrode plate, a negative electrode plate, and a separator. The positive electrode plate and the negative electrode plate may be formed of different materials, and may be assembled with the separator interposed therebetween.

### SUMMARY

Embodiments are directed to an electrode assembly, a secondary battery using the same, and a method of forming the electrode assembly, which substantially overcome one or more of the problems due to the limitations and disadvantages of the related art.

It is therefore a feature of an embodiment to provide an electrode assembly having parts of uncoated areas of electrode plates cut and folded to form tab sets, thereby eliminating a need to attach an additional tab.

It is therefore another feature of an embodiment to provide an electrode assembly with a multi-tab having a plurality of tab sets, thereby facilitating application to a large battery.

It is yet another feature of an embodiment to provide a secondary battery using an electrode assembly having one or more of the above features.

It is still another feature of an embodiment to provide a method of forming an electrode assembly having one or more of the above features.

At least one of the above and other features and advantages may be realized by providing an electrode assembly, including a positive electrode plate having a positive electrode active material layer obtained by coating a positive electrode active material on both surfaces of a positive electrode collector and positive electrode uncoated areas on which the positive electrode active material is not coated, a negative electrode plate including a negative electrode active material layer obtained by coating a negative electrode active material on both surfaces of a negative electrode collector and negative electrode uncoated areas on which the negative electrode active material is not coated, a separator interposed between the positive electrode plate and the negative electrode plate, and a positive electrode tab set and a negative electrode tab set. The positive electrode tab set includes a plurality of positive electrode tabs being folded portions of the positive electrode uncoated areas and being coupled to each other, and the negative electrode tab set includes a plurality of negative electrode tabs being folded portions of the negative uncoated areas and being coupled to each other.

According to another aspect of the present invention, the positive electrode uncoated areas may be arranged at one end in a width direction of the positive electrode collector, and the negative electrode uncoated areas may be arranged at the other end in the width direction of the negative electrode collector. The positive electrode uncoated areas may include a plurality of first cut areas separated from each other in longitudinal directions of the positive electrode collector, and the negative electrode uncoated areas may include a plurality of second cut areas separated from each other in longitudinal directions of the negative electrode collector.

According to still another aspect of the present invention, the positive electrode active material and the negative electrode active material may be intermittently coated in the longitudinal directions of the positive electrode collector and the negative electrode collector, and the first cut areas and the second cut areas may be formed between the intermittently coated positive electrode collector and negative electrode collector. The positive and negative electrode tab sets may be arranged in the uncoated areas between the respective intermittent positive and negative electrode active materials. The positive electrode tab sets and the negative electrode tab sets of the tab set may be formed not to substantially overlap each other.

The positive electrode plate and the negative electrode plate may be formed so that the positive electrode active material layer and the negative electrode active materially layer substantially overlap each other.

The first cut areas and the second cut areas may be separated from each other to be longer from the inside where winding starts to the outside where winding ends.

The tab set may be obtained by overlapping the first cut areas and the second cut areas. The tab set may be coupled by welding or screw fastening.

Lead tabs may be coupled to at least one positive electrode tab sets and negative electrode tab sets of the tab set. The lead tabs may be welded or screw fastened to the tab set.

The lead tabs may further include screw fastening holes so that the lead tabs are coupled to a cap plate.

The folded portions may be partially cut portions of respective positive and negative electrode uncoated areas. The folded portions of the positive and negative electrode uncoated areas may substantially overlap parts of respective positive and negative electrode uncoated areas, and the folded portions may extend beyond respective positive and negative electrode uncoated areas.

The positive and negative electrode uncoated areas may include openings adjacent to the folded portions, the openings being co-linear with the folded portions and having a same shape as the folded portions.

Each of the positive and negative electrode tab sets may be integral with a respective positive and negative electrode plate.

At least one of the above and other features and advantages may also be realized by providing a secondary battery, including an electrode assembly in a can, a cap plate sealing an opening of the can, and an electrode terminal inserted through a hole in the cap plate, wherein the electrode assembly includes a positive electrode plate including a positive electrode active material layer and, positive electrode uncoated areas on a positive collector, the positive electrode active material layer having a positive electrode active material on the positive electrode collector, and the positive electrode uncoated areas having no positive electrode active material, a negative electrode plate including a negative electrode active material layer and negative electrode uncoated areas on a negative collector, the negative electrode active material layer having a negative electrode active material on the negative electrode collector, and the negative electrode uncoated areas having no negative electrode active material, a separator interposed between the positive electrode plate and the negative electrode plate, and a tab set including positive electrode tab sets and negative electrode tab sets, the positive electrode tab sets being folded portions of the positive electrode uncoated areas coupled to each other, and the negative electrode tab sets being folded portions of the negative electrode uncoated areas coupled to each other.

At least one of the above and other features and advantages may also be realized by providing a method of forming an electrode assembly, including forming a positive electrode plate including a positive electrode active material layer and positive electrode uncoated areas on a positive collector, the positive electrode active material layer having a positive electrode active material on the positive electrode collector, and the positive electrode uncoated areas having no positive electrode active material, forming a negative electrode plate including a negative electrode active material layer and negative electrode uncoated areas on a negative collector, the negative electrode active material layer having a negative electrode active material on the negative electrode collector, and the negative electrode uncoated areas having no negative electrode active material, forming a separator interposed between the positive electrode plate and the negative electrode plate, and forming a tab set including positive electrode tab sets and negative electrode tab sets, the positive electrode tab sets being folded portions of the positive electrode uncoated areas coupled to each other, and the negative electrode tab sets being folded portions of the negative electrode uncoated areas coupled to each other.

Forming the positive electrode tab sets and negative electrode tab sets may include cutting first parts of the positive electrode uncoated areas and second parts of the negative electrode uncoated areas, folding the first and second cut parts of the positive and negative electrode uncoated areas, respectively, such that the folded first and second cut parts protrude away from the electrode assembly, and coupling to each other each of the positive electrode tab sets and the negative electrode tab sets. Coupling the positive electrode tab sets and the negative electrode tab sets may include welding. Coupling the positive electrode tab sets and the negative electrode tab sets may include fastening by screws.

### BRIEF DESCRIPTION OF THE DRAWINGS

The above and other features and advantages will become more apparent to those of ordinary skill in the art by describing in detail exemplary embodiments with reference to the attached drawings, in which:

FIG. 1 illustrates a plan view of an electrode plate according to a first embodiment;

FIG. 2 illustrates a perspective view of an unwound electrode assembly according to the first embodiment;

FIG. 3A illustrates a perspective view of a wound electrode assembly according to the first embodiment;

FIG. 3B illustrates a perspective view of a wound electrode assembly according to a second embodiment;

FIG. 4A illustrates a plan view of a positive electrode plate according to a third embodiment;

FIG. 4B illustrates a plan view of a negative electrode plate according to the third embodiment;

FIG. 5A illustrates a perspective view of an unwound electrode assembly according to the third embodiment;

FIG. 5B illustrates a plan view of an unwound electrode assembly according to the third embodiment;

FIGS. 6A to 6E illustrate perspective views of stages of winding an electrode assembly according to the third embodiment and connecting tabs thereof; and

FIG. 7 illustrates an exploded perspective view of an electrode assembly in a can according to the first embodiment.

### DETAILED DESCRIPTION

Korean Patent Application No. 10-2009-0126077, filed on Dec. 17, 2009, in the Korean Intellectual Property Office, and entitled: “Electrode Assembly and Secondary Battery Using the Same,” is incorporated by reference herein in its entirety.

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the invention to those skilled in the art.

In the drawing figures, the dimensions of elements and regions may be exaggerated for clarity of illustration. It will also be understood that when a layer or element is referred to as being “on” another element or substrate, it can be directly on the other element or substrate, or intervening elements may also be present. Further, it will be understood that when an element is referred to as being “connected to” another element, they can be directly connected, or one or more intervening elements may also be present. In addition, it will also be understood that when an element is referred to as being “between” two elements, it can be the only element between the two elements, or one or more intervening element may also be present. Like reference numerals refer to like elements throughout.

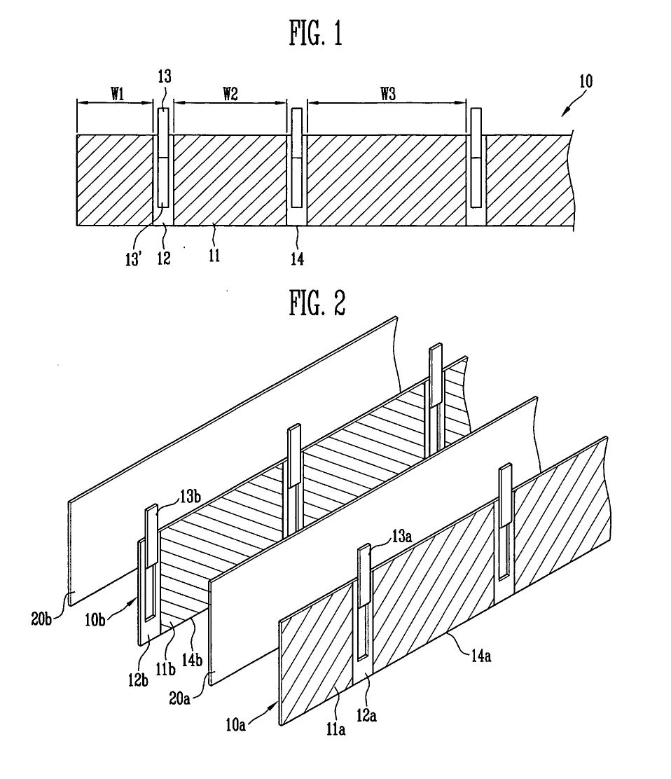

Hereinafter, an electrode assembly according to example embodiments will be described in detail with reference to the drawings. FIG. 1 illustrates a plan view of an electrode plate according to a first embodiment.

Referring to FIG. 1, an electrode plate 10, i.e., either a positive electrode plate or a negative electrode plate, according to the first embodiment may include an active material layer 11 on a collector 14. The active material layer 11 may include an active material coated intermittently on both surfaces of the collector 14 in a longitudinal direction of the collector 14, e.g., the active material layer 11 may include portions of active material that are spaced apart from each other on the collector 14 along the longitudinal direction of the collector 14. Uncoated areas 12, i.e., regions of the collector 14 on which the active material is not coated, may be defined between the spaced portions of the active material layer 11. That is, as illustrated in FIG. 1, the active material layer 11 and the uncoated areas 12 may be formed alternately.

Cut areas 13 may be formed in the uncoated areas 12. That is, portions of the uncoated areas 12 may be partially cut, e.g., each cut portion may be connected to a respective uncoated area 12 only at one side, so the cut portion may be folded at a connection region between the cut portion and the uncoated area 12 to form the cut area 13. In other words, the cut portions may be folded to define openings 13′ in the uncoated area 12, so the cut areas 13 may extend above the openings 13′ to protrude beyond the electrode plate 10. The cut portions may have any suitable shape, e.g., a rectangular shape, and may be longer than a part of the uncoated area 12 overlapping the cut area 13. That is, the cut area 13 may be folded along a direction substantially perpendicular to the longitudinal direction of the collector 14, so the cut area 13 may protrude out of the collector 14, e.g., illustrated as protruding upward in FIG. 1. Since the cut area 13 overlaps a remaining portion of the uncoated area 12 and protrudes above the remaining portion of the uncoated area 12, the cut portion of the uncoated area 12 may be sufficiently long to overlap the remaining portion of the uncoated area 12 and protrude above it.

The plurality of cut areas 13 may function as electrode tabs when an electrode assembly is formed. Therefore, when the electrode plate 10 is wound, the plurality of cut areas 13 may be arranged to overlap each other, as will be discussed in more detail below.

In order to ensure overlap of the cut areas 13, lengths of the portions of the active material layer 11 on the collector 14 may vary. In particular, the active material may be intermittently coated on the electrode plate 10 to be longer from the inside where the winding starts to the outside where the winding ends. In other words, a length of the portions of the active material layer 11 along the longitudinal direction of the collector 14 may increase, as a distance from a winding starting point increases. For example, as illustrated in FIG. 1, a length of the active material in the first portion of the active material layer 11, i.e., a portion where the winding starts, may be W1, a length of the active material in the second portion of the active material layer 11, i.e., a portion adjacent to the first portion, may be W2, and a length of the active material in the third portion may be W3, so a relationship of W1<W2<W3 may be established.

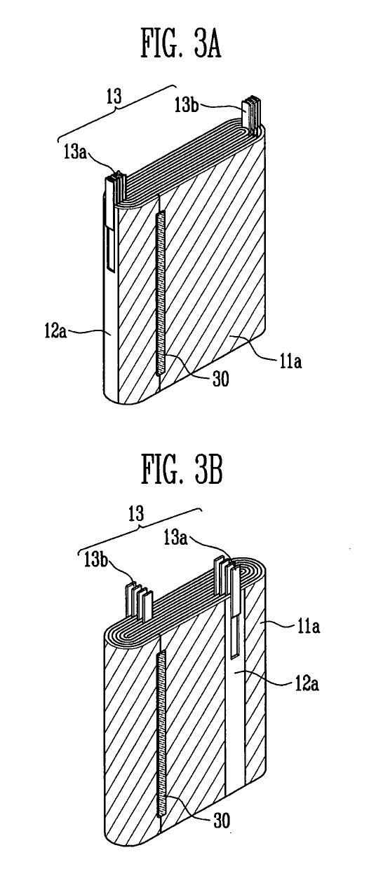

FIG. 2 illustrates a perspective view of an exploded, unwound state of an electrode assembly according to the first embodiment. It is noted that FIG. 2 refers to substantially same elements described previously with reference to FIG. 1, with the exception of indicating each element with character reference (a) or (b) to define positive or negative elements, respectively.

Referring to FIG. 2, a positive electrode plate 10b may include a positive electrode active material layer 11b, i.e., obtained by coating a positive electrode active material on both surfaces of a positive electrode collector 14b, and positive electrode uncoated areas 12b, on which the positive electrode active material is not coated. A negative electrode plate 10a may include a negative electrode active material layer 11a, i.e., obtained by coating a negative electrode active material on both surfaces of a negative electrode collector 14a, and negative electrode uncoated areas 12a, on which the negative electrode material is not coated. First cut areas 13a and second cut areas 13b may be formed in the negative electrode uncoated areas 12a and the positive electrode uncoated areas 12b, respectively, so that the first cut areas 13a and the second cut areas 13b may be folded to protrude away, e.g., upward, from the respective collectors 14a and 14b to be used as positive electrode tabs and negative electrode tabs.

As further illustrated in FIG. 2, the electrode assembly may include a first separator 20a and a second separator 20b adjacent to the negative and positive electrode plates 10a and 10b. For example, the first separator 20a may be positioned between the negative electrode plate 10a and the positive electrode plate 10b, and the positive electrode plate 10b may be positioned between the first and second separators 20a and 20b. Therefore, the negative electrode plate 10a and the positive electrode plate 10b may be insulated from each other. In addition, the first separator 20a and the second separator 20b may have active material ions exchanged between the negative electrode plate 10a and the positive electrode plate 10b. The first separator 20a and the second separator 20b may have enough length to completely insulate the negative electrode plate 10a and the positive electrode plate 10b from each other although the electrode assembly may contract and expand.

The positive electrode active material and the negative electrode active material may be intermittently coated in the longitudinal directions of the negative electrode collector 14a and the positive electrode collector 14b to form the negative and positive electrode active material layers 11a and 11b. The negative electrode uncoated areas 12a and the positive electrode uncoated areas 12b may be formed between the intermittently coated portions of the negative and positive active material layers 11a and 11b, e.g., alternately therewith. The first cut areas 13a and the second cut areas 13b may be provided in the negative electrode uncoated areas 12a and the positive electrode uncoated areas 12b, respectively. The first cut areas 13a and the second cut areas 13b may be folded to protrude upward to define positive electrode tabs and negative electrode tabs, respectively.

The electrode assembly may be accommodated in an exterior container, e.g., a can or a pouch, and may be formed by sequentially laminating the positive electrode plate 10b, the first and second separators 20a and 20b, and the negative electrode plate 10a. The electrode assembly may be formed by sequentially laminating the positive electrode plate 10b, the first and second separators 20a and 20b, and the negative electrode plate 10a, and winding the laminated positive electrode plate 10b, the first and second separators 20a and 20b, and the negative electrode plate 10a.

The positive electrode plate 10b may include the, e.g., sheet shaped, positive electrode collector 14b and the positive electrode active material coated on both surfaces of the positive electrode collector 14b. The negative electrode plate 10a may include the, e.g., sheet shaped, negative electrode collector 14a and the negative electrode active material coated on both surfaces of the negative electrode collector 14a. The first separator 20a and the second separator 20b may be positioned between the positive electrode plate 10b and the negative electrode plate 10a and on one side of the positive electrode plate 10b to prevent electrical short between the positive electrode plate 10b and the negative electrode plate 10a and to allow lithium ions to move.

Examples of the positive electrode active material may include a lithium containing transition metal oxide or a lithium chalcogenide compound, e.g., LiCoO₂, LiNiO₂, LiMnO₂, LiMn₂O₄, or LiNi_{1-x-y}CoₓMyO₂ (0≦x≦1, 0≦y≦1, 0<x+y<1, and M is a metal such as Al, Sr, Mg, and La). Examples of the negative electrode active material may include a carbon material, e.g., crystalline carbon, amorphous carbon, carbon composite, and carbon fiber, a lithium metal, or a lithium alloy.

The negative electrode collector 14a and the positive electrode collector 14b may be made of one or more of stainless steel, nickel, copper, aluminum, an alloy of the above metals, etc; e.g., a thin aluminum foil. In order to maximize efficiency, the positive electrode collector 14b may be made of aluminum or an aluminum alloy, and the negative electrode collector 14a may be made of copper or a copper alloy. The first and second separators 20a and 20b may be made of, e.g., a polyolefin based polymer layer and a multi-layer.

FIG. 3A illustrates a perspective view of a wound state of the electrode assembly according to the first embodiment. Referring to FIG. 3A, the electrode assembly may be obtained by winding the sequentially laminated negative electrode plate 10a, first and second separators 20a and 20b, and positive electrode plate 10b.

As illustrated in FIG. 3A, the electrode assembly may be wound, so the plurality of first cut areas 13a, i.e., negative electrode tab sets 13a, and the plurality of second cut areas 13b, i.e., positive electrode tab sets 13b, may protrude in a same direction, e.g., upward, from the electrode assembly to form a tab set 13. In other words, the tab set 13 may include the positive electrode tab sets 13b and the negative electrode tab sets 13b that protrude out of the wound electrode assembly in a same direction. The negative electrode tab sets 13a may be formed on the side of the negative electrode uncoated areas 12a, and the positive electrode tab sets 13b may be formed on the other side, i.e., on the side of the positive electrode uncoated areas 12b.

The electrode assembly may be wound so the negative electrode tab sets 13a and the positive electrode tab sets 13b overlap each other. That is, as illustrated in FIG. 3A, the negative electrode tab sets 13a may be positioned at one side of the electrode assembly to, e.g., completely, overlap each other, and the positive electrode tab sets 13b may be positioned at an opposite side of the electrode assembly to, e.g., completely, overlap each other. For example, as further illustrated in FIG. 3A, the negative electrode tab sets 13a may face and overlap the positive electrode tab sets 13b, i.e., the positive and negative electrode tab sets 13b and 13a may be on opposite narrow surfaces of the electrode assembly. The negative and positive electrode tab sets 13a and 13b may be fixed by welding, e.g., supersonic welding or screw fastening.

In a second exemplary embodiment, as illustrated in FIG. 3B, the positive electrode tab sets 13b may not overlap the negative electrode tab sets 13a. That is, referring to FIG. 3B, the negative electrode tab sets 13a may overlap each other and face forward, i.e., extend from a first major surface of the electrode assembly, and the positive electrode tab sets 13b may overlap each other and face rearward, i.e., extend from a second major surface of the electrode assembly opposite the first major surface. The negative electrode tab sets 13a may be spaced apart, e.g., offset, from the positive electrode tab sets 13b along a longitudinal axis. It is noted that the positions of the negative electrode tab sets 13a and the positive electrode tab sets 13b may be changed and are not limited to the above. That is, the negative electrode tab sets 13a and the positive electrode tab sets 13b may be arranged in any positions where the negative electrode tab sets 13a and the positive electrode tab sets 13b may be separated from each other. Reference numeral 30 denotes a tape, i.e., a tape for securing a lose end of the wound electrode assembly.

Since lengths of the active material on the collectors 14a and 14b increase as a distance from a starting winding point increases, i.e., lengths are longer from the inside where the negative electrode plate 10a and the positive electrode plate 10b start being wound to the outside where the negative electrode plate 10a and the positive electrode plate 10b stop being wound, the negative electrode uncoated areas 12a and the positive electrode uncoated areas 12b may be formed to overlap each other as the electrode assembly is wound. That is, lengths of the portions of the active materials layers 11a and 11b, e.g., W1 through W3, may be adjusted, so the negative and positive electrode uncoated areas 12a and 12b may, e.g., completely, overlap each other when the electrode assembly is in a wound state.

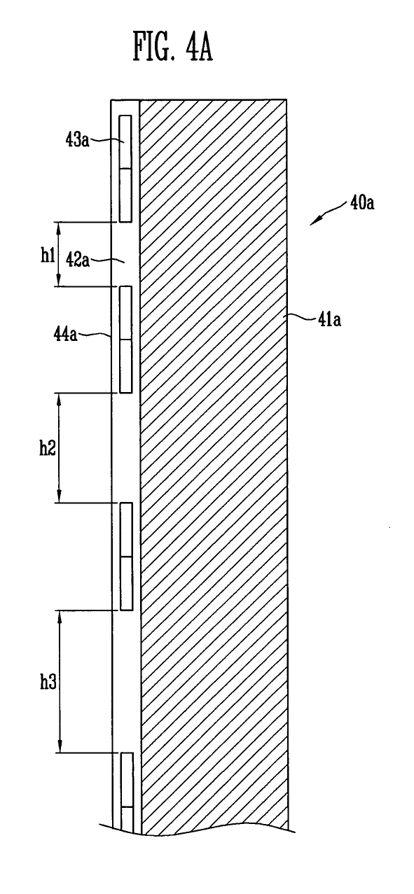

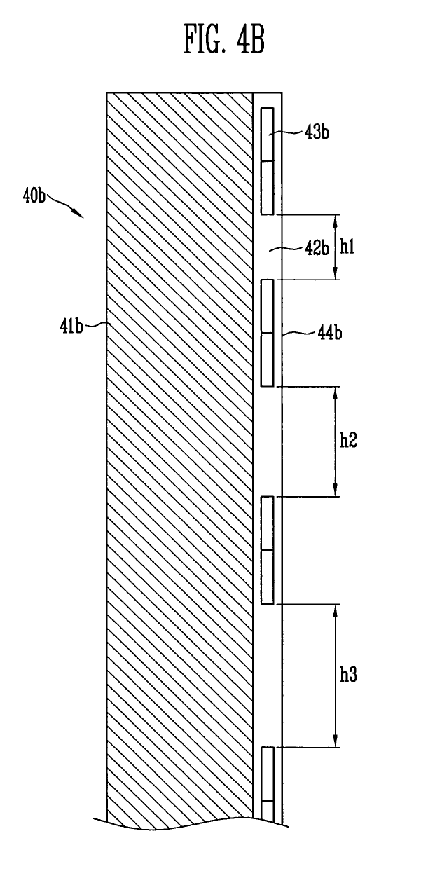

FIG. 4A illustrates a plan view of a positive electrode plate according to a third embodiment. FIG. 4B illustrates a plan view of a negative electrode plate according to the third embodiment.

Referring to FIG. 4A, a positive electrode plate 40a may include a positive electrode active material layer 41a on a positive electrode collector 44a, and a positive electrode uncoated area 42a. The positive electrode active material layer 41a may be continuously coated on the positive electrode collector 44a, and the positive electrode uncoated area 42a may be continuously formed at one end of the positive electrode collector 44a. The positive electrode active material layer 41a and the positive electrode uncoated area 42a may extend continuously along a longitudinal direction of the positive electrode collector 44a, and may be adjacent to each other in a width direction of the positive electrode collector 44a. FIG. 4B illustrates a negative electrode plate 40b and a negative electrode uncoated area 42b formed at end thereof in the width direction of the negative electrode collector 44b.

As further illustrated in FIGS. 4A and 4B, a plurality of first cut areas 43a and second cut areas 43b may be formed in respective positive and negative electrode uncoated areas 42a and 42b. The first and second cut areas 43a and 43b may be separated from each other in the longitudinal direction of the collectors 44a and 44b within each of the positive and negative electrode uncoated areas 42a and 42b, e.g., the first cut areas 43a may be separated from each other in the longitudinal direction of the collector 44a within the positive electrode uncoated area 42a.

First distances between adjacent first cut areas 43a and second distances between adjacent second cut areas 43b may increase from the inside where winding starts to the outside where winding ends. For example, as illustrated in FIGS. 4A-4B, the first and second distances, i.e., between cut areas 43a and 43b formed in the parts where winding starts and the secondly formed cut areas 43a and 43b, may be h1, the first and second distances between the secondly formed cut areas 43a and 43b and the thirdly formed cut areas 43a and 43b may be h2, and the first and second distances between the thirdly formed cut areas 43a and 43b and the fourthly formed cut areas 43a and 43b may be h3, so the relationship of h1<h2<h3 may be established:

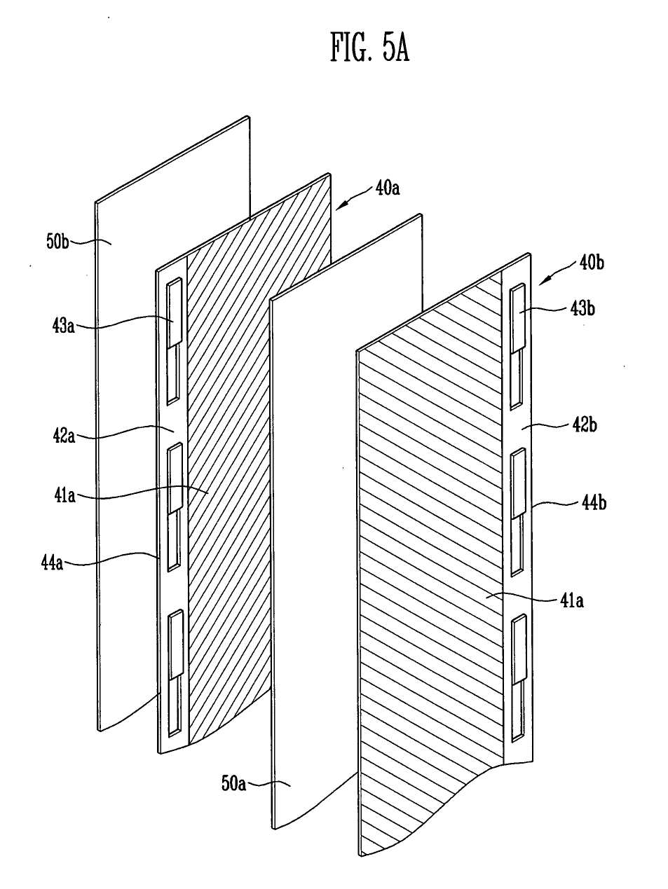

FIG. 5A illustrates a perspective exploded view of an unwounded electrode assembly according to the third embodiment. FIG. 5B illustrates a plan view of an assembled, unwound electrode assembly according to the third embodiment.

Referring to FIGS. 5A and 5B, the positive electrode plate 40a may include the positive electrode active material layer 41a, i.e., obtained by coating a positive electrode active material on both surfaces of the positive electrode collector 44a, and the positive electrode uncoated area 42a, i.e., obtained by not coating the positive electrode active material on one end of the positive electrode collector 44a. The negative electrode plate 40b may include the negative electrode active material layer 41b, i.e., obtained by coating a negative electrode active material on both surfaces of the negative electrode collector 44b, and the negative electrode uncoated area 42b, i.e., obtained by not coating the negative electrode active material on one end of the negative electrode collector 44b. The first cut areas 43a and the second cut areas 43b may be formed in the positive electrode uncoated area 42a and the negative electrode uncoated area 42b to be separated from each other in the longitudinal direction, so that the first cut areas 43a and the second cut areas 43b may be folded to protrude upward and that the first cut areas 43a and the second cut areas 43b may be used as positive electrode tabs and negative electrode tabs. A first separator 50a and a second separator 50b may be positioned between one side of each of the positive electrode plate 40a and the negative electrode plate 40b and on the other side of the positive electrode plate 40a to insulate the positive electrode plate 40a and the negative electrode plate 40b.

The positive electrode plate 40a and the negative electrode plate 40b may be arranged so that only the positive electrode active material layer 41a and the negative electrode active material layer 41b overlap each other. That is, in the state where the positive electrode plate 40a, the negative electrode plate 40b, and the separators 50a and 50b overlap each other, the positive electrode uncoated area 42a and the negative electrode uncoated area 42b may protrude at both ends in a longitudinal direction. As illustrated in FIG. 5A, the positive electrode uncoated area 42a may protrude to one side, and the negative electrode uncoated area 42b may protrude to an opposite side. As illustrated in FIG. 5B, the plurality of first cut areas 43a and the plurality of second cut areas 43b may protrude in opposite direction from the collectors plates 40a and 40b, and may be separated from each other to be longer from the inside where winding starts to the outside where winding ends.

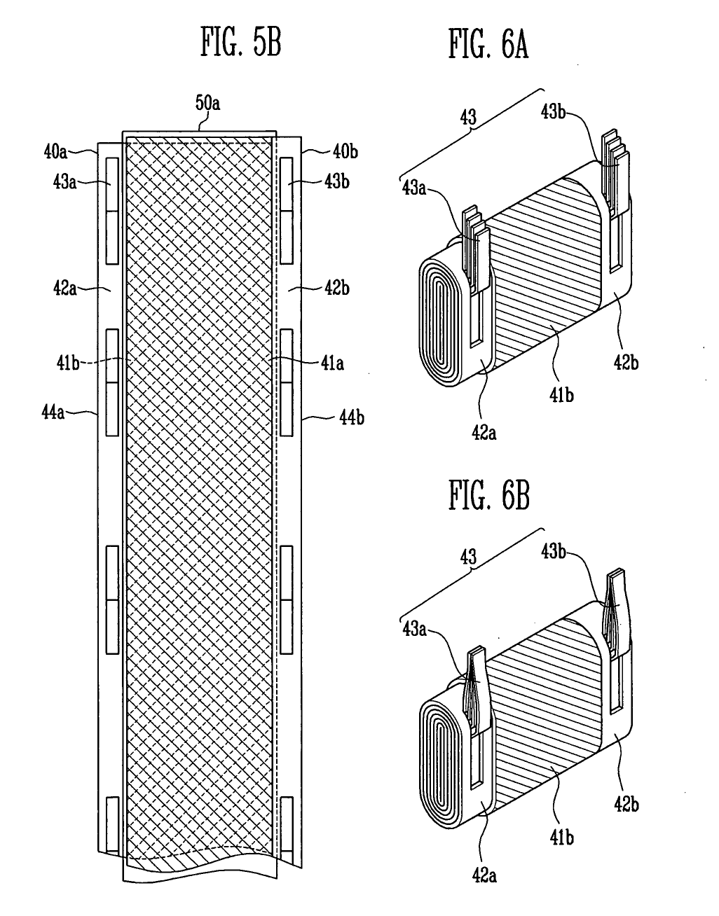

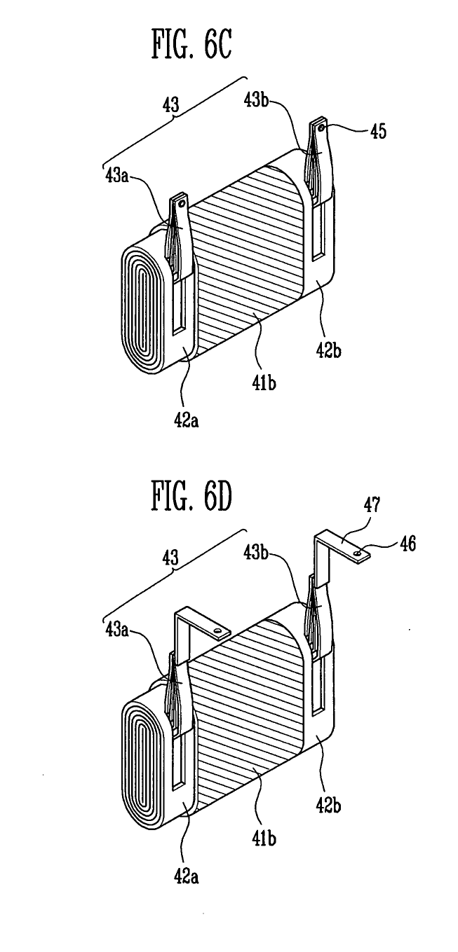

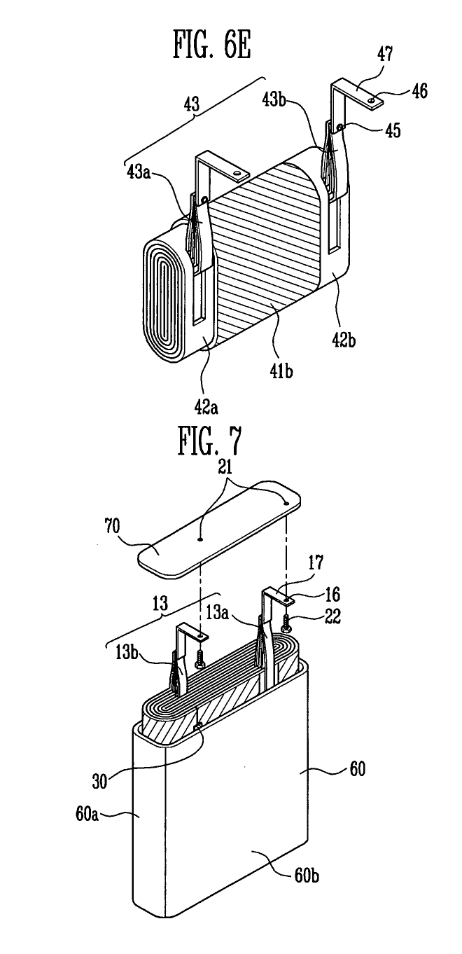

FIGS. 6A to 6E illustrate perspective views of a state in which the electrode assembly according to the third embodiment of the present invention is wound.

First, referring to FIG. 6A, the electrode assembly in FIGS. 5A and 5B may be wound, so the positive electrode tab sets 43a overlap each other and the negative electrode tab sets 43b overlap each other. The first cut areas, i.e., positive electrode tab sets 43a formed in the positive electrode uncoated area 42a, may be folded to protrude away from the positive electrode uncoated area 42a in a same direction, e.g., upward, so that the positive electrode tab sets 43a may be positioned at one end of the electrode assembly to overlap each other. Similarly, the second cut areas, i.e., negative electrode tab sets 43b formed in the negative electrode uncoated area 42b, may be folded to protrude away from the negative electrode uncoated area 42b in a same direction, e.g., upward, so that the negative electrode tab sets 43b may be positioned at one end, i.e., different end than the positive electrode tab sets 43a, of the electrode assembly to overlap each other. Since the plurality of the positive and negative electrode tab sets 43a and 43b are formed at both ends of each of the positive electrode plate 40a and the negative electrode plate 40b in a longitudinal direction, the positive and negative electrode tab sets 43a and 43b may protrude in a direction perpendicular to a surface where the wound electrode assembly is revealed. In addition, the positive electrode tab sets 43a, i.e., formed by folding the plurality of first cut areas to be bent or protrude upward, and the negative electrode tab sets 43b, i.e., formed by folding the plurality of second cut areas to be bent or protrude upward, may be fixed, e.g., by welding or screw fastening.

Next, referring to FIG. 6B, the plurality of positive electrode tab sets 43a may be fixed to each other at the leading ends, e.g., by welding, to be coupled to each other. Similarly, the plurality of negative electrode tab sets 43b may be fixed to each other at the leading ends, e.g., by welding, to be coupled to each other. The positive and negative electrode tab sets 43a and 43b may be referred to as a tab set 43.

Referring to FIG. 6C, it is noted that each of the positive electrode tab sets 43a and the negative electrode tab sets 43b may be additionally or alternatively fastened at the leading ends, e.g., by screws 45, to be coupled to each other.

Next, referring to FIG. 6D, an additional lead tab 47 may be fixed to leading ends of each of the positive electrode tab sets 43a and the negative electrode tab sets 43b, e.g., by welding. Additional screw fastening holes 46 may be provided in the lead tabs 47, so that the lead tabs 47 may be fixed to a cap assembly (not shown).

As illustrated in FIG. 6E, the additional lead tab 47 may be additionally or alternatively fastened to each of the positive electrode tab sets 43a and the negative electrode tab sets 43b by the screws 45. In addition, the additional screw fastening holes 46 may be provided in the lead tabs 47, so that the lead tabs 47 may be fixed to the cap assembly (not shown).

FIG. 7 illustrates an exploded perspective view of the electrode assembly in a can according to the second example embodiment. It is noted, however, that any of the electrode assemblies of the first through third embodiments may be used.

Referring to FIG. 7, a secondary battery according to example embodiments may include an electrode assembly, a can 60, and a cap assembly 70. An additional insulating case (not shown) may be provided between the electrode assembly and the cap assembly 70. The cap assembly 70 may have various structures to include a cap plate (not shown).

As noted in FIG. 7, the negative electrode tab sets 13a formed by the first cut areas and the positive electrode tab sets 13b formed by the second cut areas may protrude above an upper end of the electrode assembly. At this time, in the electrode assembly, the negative electrode tab sets 13a may be separated from the positive electrode tab sets 13b by a predetermined distance to be electrically insulated from each other. The negative and positive electrode tab sets 13a and 13b may be withdrawn in a direction where the can 60 is opened. Additional lead tabs 17 may be fixed to the leading ends of the tab set 13, e.g., as described previously with reference to FIGS. 6A-6F. Screw fastening holes 16 may be formed in the lead tabs 17, so that screws 22 may pass through the screw fastening holes 16 of the lead tabs 17 and through openings 21 of the cap assembly 70 to fix the tab set 13 and the cap assembly 70 to each other. The can 60 may accommodate the electrode assembly through its open side, and a horizontal section of the can 60 may be, e.g., a square with rounded edges. The can 60 may include a pair of short sides 60a and a pair of long sides 60b. The shape of the horizontal section of the can 60 may not be limited to the above. Although not shown, the shape of the horizontal section of the can 60 may be, e.g., square or elliptical. For example, the can 60 may be formed of light and flexible aluminum or an aluminum alloy. In addition, the can 60 may be easily manufactured by a deep drawing method.

According to example embodiments, portions of electrode plates may be coated with the active material, so parts of the uncoated areas may be bent and folded to form a tab set. As such, internal resistance (IR) in the electrode assembly may be reduced, and a process of welding separate tabs to the electrode plates may be omitted. In contrast, when conventional electrode tabs are welded to the negative and/or positive electrode plates, since the electrode tabs are attached to different materials via welding, an internal resistance may increase to enhance heat emission in the electrode assembly.

Further, according to example embodiments, as the plurality of negative and positive electrode tab sets overlap each other, the electrode assembly may include a multi-tab. As such, the electrode assembly may be applied to a large battery. In contrast, when a conventional electrode assembly includes a single positive electrode tab and a single negative electrode tab that are applied to a large battery, operation characteristic of the large battery may not be satisfied.

Exemplary embodiments have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. An electrode assembly, comprising:
a positive electrode plate including a positive electrode active material layer and positive electrode uncoated areas on a positive collector, the positive electrode active material layer having a positive electrode active material on the positive electrode collector, and the positive electrode uncoated areas having no positive electrode active material;
a negative electrode plate including a negative electrode active material layer and negative electrode uncoated areas on a negative collector, the negative electrode active material layer having a negative electrode active material on the negative electrode collector, and the negative electrode uncoated areas having no negative electrode active material;
a separator interposed between the positive electrode plate and the negative electrode plate; and
a positive electrode tab set and a negative electrode tab set, wherein the positive electrode tab set includes a plurality of positive electrode tabs being folded portions of the positive electrode uncoated areas and being coupled to each other, and the negative electrode tab set includes a plurality of negative electrode tabs being folded portions of the negative uncoated areas and being coupled to each other.

2. The electrode assembly as claimed in claim 1, wherein:
the positive electrode uncoated areas are arranged at one end in a width direction of the positive electrode collector and the negative electrode uncoated areas are arranged at the other end in the width direction of the negative electrode collector, and
the positive electrode uncoated areas include a plurality of first cut areas separated from each other in longitudinal directions of the positive electrode collector and the negative electrode uncoated areas include a plurality of second cut areas separated from each other in longitudinal directions of the negative electrode collector.

3. The electrode assembly as claimed in claim 1, wherein:
each of the positive electrode active material and the negative electrode active material is intermittently arranged in a longitudinal direction of the positive electrode collector and the negative electrode collector, respectively, and
the positive and negative electrode tab sets are arranged in the uncoated areas between the respective intermittent positive and negative electrode active materials.

4. The electrode assembly as claimed in claim 3, wherein the positive electrode tab sets are offset with respect to the negative electrode tab sets in a wound electrode assembly.

5. The electrode assembly as claimed in claim 1, wherein the positive electrode plate and the negative electrode plate are arranged to have the positive electrode active material layer and the negative electrode active material layer substantially overlap each other.

6. The electrode assembly as claimed in claim 1, wherein in each of the positive electrode tabs and the negative electrode tabs, a distance between adjacent positive and negative electrode tabs increases, as a distance from a starting winding point increases.

7. The electrode assembly as claimed in claim 1, wherein, in a wound state of the electrode assembly, the positive electrode tabs substantially overlap each other and the negative electrode tabs substantially overlap each other.

8. The electrode assembly as claimed in claim 7, wherein the positive electrode tabs are coupled to each other, and the negative electrode tabs are coupled to each other.

9. The electrode assembly as claimed in claim 8, further comprising a lead tab coupled to at least one of the positive electrode tab sets and the negative electrode tab sets.

10. The electrode assembly as claimed in claim 9, wherein the lead tab includes at least one screw fastening hole.

11. The electrode assembly as claimed in claim 1, wherein the folded portions are partially cut portions of respective positive and negative electrode uncoated areas.

12. The electrode assembly as claimed in claim 11, wherein the folded portions of the positive and negative electrode uncoated areas overlap parts of respective positive and negative electrode uncoated areas, and the folded portions extend beyond respective positive and negative electrode uncoated areas.

13. The electrode assembly as claimed in claim 1, wherein the positive and negative electrode uncoated areas include openings adjacent to the folded portions, the openings being co-linear with the folded portions and having a same shape as the folded portions.

14. The electrode assembly as claimed in claim 1, wherein each of the positive and negative electrode tabs is integral with a respective positive and negative electrode plate.

15. A secondary battery, comprising:
an electrode assembly in a can;
a cap plate sealing an opening of the can; and
an electrode terminal inserted through a hole in the cap plate,
wherein the electrode assembly includes:
a positive electrode plate including a positive electrode active material layer and positive electrode uncoated areas on a positive collector, the positive electrode active material layer having a positive electrode active material on the positive electrode collector, and the positive electrode uncoated areas having no positive electrode active material,
a negative electrode plate including a negative electrode active material layer and negative electrode uncoated areas on a negative collector, the negative electrode active material layer having a negative electrode active material on the negative electrode collector, and the negative electrode uncoated areas having no negative electrode active material,
a separator interposed between the positive electrode plate and the negative electrode plate, and
a tab set including positive electrode tab sets and negative electrode tab sets, the positive electrode tab sets being folded portions of the positive electrode uncoated areas connected to each other, and the negative electrode tab sets being folded portions of the negative electrode uncoated areas connected to each other.

16. A method of forming an electrode assembly, comprising:
forming a positive electrode plate including a positive electrode active material layer and positive electrode uncoated areas on a positive collector, the positive electrode active material layer having a positive electrode active material on the positive electrode collector, and the positive electrode uncoated areas having no positive electrode active material;
forming a negative electrode plate including a negative electrode active material layer and negative electrode uncoated areas on a negative collector, the negative electrode active material layer having a negative electrode active material on the negative electrode collector, and the negative electrode uncoated areas having no negative electrode active material;
forming a separator interposed between the positive electrode plate and the negative electrode plate; and
forming a tab set including positive electrode tab sets and negative electrode tab sets, the positive electrode tab sets being folded portions of the positive electrode uncoated areas connected to each other, the negative electrode tab sets being folded portions of the negative electrode uncoated areas connected to each other, wherein forming the positive electrode tab sets and negative electrode tab sets includes:
cutting first parts of the positive electrode uncoated areas and second parts of the negative electrode uncoated areas,
folding the first and second cut parts of the positive and negative electrode uncoated areas, respectively, such that the folded first and second cut parts protrude away from the electrode assembly; and
coupling to each other each of the positive electrode tab sets and the negative electrode tab sets.

17. The method as claimed in claim 18, wherein coupling the positive electrode tab sets and the negative electrode tab sets includes welding.

18. The method as claimed in claim 18, wherein coupling the positive electrode tab sets and the negative electrode tab sets includes fastening by screws.
